(19) United States
(12) Patent Application Publication
(10) Pub. No.: US 2026/0338134 A1
(43) Pub. Date: Oct. 29, 2026

(54) THRUST REVERSER COMPRISING A SEALING MEMBRANE PROVIDED WITH A SEAL

(71) Applicant: SAFRAN NACELLES, Gonfreville-L'Orcher (FR)

(72) Inventors: Patrick GONIDEC, Moissy-Cramayel (FR); Patrick André BOILEAU, Moissy-Cramayel (FR); Julien CHANDELIER, Moissy-Cramayel (FR); François BELLET, Moissy-Cramayel (FR)

(73) Assignee: SAFRAN NACELLES, Gonfreville-L'Orcher (FR)

(21) Appl. No.: 19/128,284

(22) PCT Filed: Nov. 14, 2023
(86) PCT No.: PCT/FR2023/051785

§ 371 Date: May 8, 2025

(30) Foreign Application Priority Data
Nov. 16, 2022 (FR) FR2211903

(51) Int. Cl. F02K 1/70

(52) U.S. Cl. CPC F02K 1/70

(57) ABSTRACT

A thrust reverser for an aircraft propulsion assembly, the reverser including a fixed structure and a movable structure including a movable reverser cowl having a radially inner wall, the movable structure being translatable relative to the fixed structure along a longitudinal central axis of the reverser, between an extended direct thrust position and a retracted reverse thrust position. A membrane for sealing the secondary air passage supports a first seal extending in a circumferential direction of the reverser, bearing against the fixed structure and against the upstream end of the wall of the movable cowl, when the movable structure occupies its extended direct thrust position.

### TECHNICAL FIELD

The invention relates to the field of nacelles and thrust reversers for an aircraft propulsion assembly, and, more particularly, to solutions allowing a seal to be produced between the fixed structure of the reverser and its movable structure, when the movable structure occupies its extended direct thrust position.

### Prior Art

Thrust reversers are devices making it possible to deflect the air flow through the propulsion assembly towards the front, so as to shorten the landing distances and limit the load on the brakes on the landers.

Cascade reversers currently used in the aeronautical sector generally comprise deflection cascades integrated into a fixed structure of the reverser, intended to be connected to a turbine engine casing. A movable structure of the reverser includes one or more movable reverser cowls, and it is mounted translatable relative to the fixed structure between an extended direct thrust position, and a retracted reverse thrust position. In the extended direct thrust position, the deflection cascades are arranged in a cavity of the movable reverser cowls, and they are isolated from the secondary air passage of the propulsion assembly by a radially inner wall of the reverser cowls. On the other hand, in the retracted reverse thrust position, the radially retracted inner wall of the reverser cowls defines a passage opening from the secondary air passage towards the deflection cascades.

To deflect at least one portion of the secondary flow towards this passage opening in the direction of the cascades, the reverser is typically also equipped with closing flaps, which, when deployed, close at least partially the secondary air passage. In a known manner, this forces the air from the secondary flow to pass through the passage opening and to join the cascades, which then generate the counter-pressure air flow towards the front.

In these conventional solutions, a seal is supported at the front of the movable cowl, by the radially inner wall, so as to be pressed against a deflection edge of the fixed structure of the reverser, when the movable structure adopts its extended direct thrust position. The seal is thus located in an area located radially immediately below the cascades of the reverser.

More recently, solutions for closing the secondary air passage using deployable membranes have been proposed, as a replacement and/or in combination with the closing flap solutions described above. Such a membrane design is, for example, known from document FR 3 076 864 A1.

In the extended direct thrust position, the closing membrane runs between the deflection edge of the fixed structure, and the upstream end of the radially inner wall of the movable cowl. This membrane then extends axially downstream, in the space defined radially between the radially inner wall of the movable cowl, and the deflection cascades. The seal solution, as described above for the closing flap design, proves unsuitable for the deployable closing membrane solution. This is because a transposition of the existing solution would cause the membrane to compress the seal and move it away from the deflection edge, making it ineffective.

Consequently, there is a need for improved sealing solutions in designs of reversers having deployable closing membranes.

### Disclosure of the Invention

In order to meet the above-mentioned need, the invention firstly relates to a thrust reverser for an aircraft propulsion assembly, the reverser comprising a fixed structure provided with a wall radially internally delimiting a secondary air passage of the propulsion assembly intended to be passed through by a secondary flow, the reverser further comprising a movable structure comprising at least one movable reverser cowl having a cavity that is open at the front and delimited between a radially outer wall and a radially inner wall of the movable reverser cowl, the movable structure being translatable relative to the fixed structure along a longitudinal central axis of the reverser, between an extended direct thrust position, and a retracted reverse thrust position wherein the fixed structure and an upstream end of the retracted radially inner wall of the reverser movable cowl allow an air passage opening through the secondary air passage to appear therebetween, the thrust reverser further comprising means for closing the secondary air passage, designed to divert at least a part of the secondary flow towards the passage opening, these means comprising at least one closing membrane deployable in the secondary air passage and running between the fixed structure and the upstream end of the radially inner wall when the movable structure occupies its extended direct thrust position.

According to the invention, said at least one membrane supports a first seal extending in a circumferential direction of the reverser, bearing on the one hand against the fixed structure and on the other hand against the upstream end of the radially inner wall of the movable cowl, when the movable structure occupies its extended direct thrust position.

The invention thus satisfactorily meets the need expressed above, by proposing a simple, reliable and efficient solution, in which the first seal is supported by the membrane itself. In addition to the fact that this solution fulfills the desired sealing function when in the extended reverse thrust position, it also contributes, in this same position, to the stabilization of the membrane.

The invention preferably provides at least one of the following optional technical features, taken alone or in combination.

Preferably, the first seal is located radially outwards relative to a zone of minimum spacing between the fixed structure and the upstream end of the radially inner wall, or radially inwards relative to this zone of minimum spacing, or even crosswise over this same zone by extending radially on either side thereof.

Preferably, the first seal is located radially outwards relative to the zone of minimum spacing, and said at least one closing membrane also supports a member for reconstituting the secondary air passage extending in the circumferential direction, being located radially inwards relative to the zone of minimum spacing so as to fill all or part of a cavity between the fixed structure and the upstream end of the radially inner wall, when the movable structure is in its extended direct thrust position.

The presence of the air passage reconstitution member makes it possible to limit the size of the aforementioned cavity, or even to remove it completely. This improves aerodynamic performance, reducing load losses on the secondary air passage. Moreover, the combination of the first seal and the air passage reconstitution member further improves holding in the membrane, when the movable structure of the reverser occupies the extended direct thrust position.

Preferably, the air passage reconstitution member comprises at least one reinforcement insert along a surface of this member, which insert radially delimits the secondary air passage inwardly, when the movable structure occupies its extended direct thrust position. This makes it possible to further promote aerodynamic continuity or significant aerodynamic continuity of this surface of the reconstitution member with the fixed structure and/or with the upstream end of the radially inner wall of the movable cowl, again in order to limit the load losses at the junction between these two elements,

Preferably, the air passage reconstitution member forms a second seal bearing, on the one hand, against the fixed structure, and on the other hand against the upstream end of the radially inner wall, when the movable structure occupies its extended direct thrust position.

Preferably, the air passage reconstitution member is located on the side of a forward-facing surface of the closing membrane. Nevertheless, installation on the other side is also possible, without departing from the scope of the invention.

Preferably, the air passage reconstitution member is located on one side of the closing membrane, and the latter further supports, on the opposite side, an additional air passage reconstitution member. This further strengthens the aerodynamic aspects.

It should be noted that all the preferential features described above for the air passage reconstitution member can be applied to the first seal.

Furthermore, it should be noted that the air passage reconstitution member is, for example, segmented in the circumferential direction, although it could be continuous over the entire length of the membrane, without departing from the scope of the invention.

In any case, this is preferably provided for the first seal, i.e. that it is continuous along the membrane that supports it, in the circumferential direction.

Preferably, the first seal is located on the side of a forward-facing surface of the closing membrane. Integration on the opposite side is also possible here, without departing from the scope of the invention.

Preferably, the first seal bears, on the one hand, against a deflection edge of the fixed structure, and on the other hand against the upstream, preferably rounded, end of the radially inner wall, when the movable structure occupies its extended direct thrust position.

Preferably, at least one of the two circumferential ends of the first seal circumferentially bears against an end seal supported by a guide member of the membrane rigidly connected to the movable cowl, when the movable structure occupies its extended direct thrust position.

The cooperation between the seals described above not only makes it possible to control the sealing at the concerned circumferential end of the membrane, but it also strengthens the guiding of the membrane during its deployment.

Preferably, the end seal circumferentially bears against a fixed seal supported by the fixed structure, when the movable structure occupies its extended direct thrust position.

Preferably, the fixed structure of the reverser comprises at least one deflection cascade arranged, when the movable structure occupies the extended direct thrust position, in the cavity of the movable cowl, while being isolated from the secondary air passage by the radially inner wall of the reverser cowl. Alternatively, the one or more deflection cascades may be integrated into the movable structure of the reverser, without departing from the scope of the invention.

It should be noted that the aforementioned cascades can either be formed in a conventional manner, for example by rigid elements made of composite material, or replaced by one or more flexible elements, such as a web or a flexible deflector membrane.

The invention further relates to an aircraft propulsion assembly comprising a turbine engine and a nacelle comprising at least one fan cowl, as well as a thrust reverser as described above.

Other advantages and features of the invention will appear in the non-limiting detailed description below.

### BRIEF DESCRIPTION OF THE DRAWINGS

The following detailed description refers to the appended drawings wherein:

FIG. 1 is a diagrammatic half longitudinal section view of a propulsion assembly comprising a thrust reverser according to a preferred embodiment of the invention, shown in a direct thrust configuration;

FIG. 2 is a diagrammatic half longitudinal section view of the reverser provided on the propulsion assembly shown in FIG. 1, with the reverser shown in the direct thrust configuration;

FIG. 3 is a diagrammatic half-view of the reverser shown in FIG. 2, shown in the reverse thrust configuration;

FIG. 3A is a diagrammatic half-view similar to that of the previous figure, with the reverser being shown according to an alternative embodiment;

FIG. 4 is a perspective view of the reverser shown in FIGS. 2 and 3, shown in a direct thrust configuration;

FIG. 5 is a perspective view of the reverser shown in FIG. 4, shown in the reverse thrust configuration;

FIG. 6 is an enlarged and more detailed partial view of a portion of the reverser shown in the previous figures, showing the first seal supported by the closing membrane, with the reverser being in an intermediate configuration between the direct thrust configuration and the reverse thrust configuration;

FIG. 7 is a view similar to that of the previous figure, with the reverser represented in the direct thrust configuration;

FIG. 8 is a view similar to that of FIG. 7, showing an alternative embodiment of the first seal;

FIG. 9 shows the first seal of the embodiment of FIG. 8, in the unstressed state;

FIG. 10 is a view similar to that of FIG. 8, with the membrane provided with more than one air passage reconstitution member;

FIG. 11 shows the first seal and the air passage reconstitution member of the embodiment of FIG. 10, in the unstressed state;

FIG. 12 is a view similar to that of FIG. 10, with the first seal and the air passage reconstitution member present according to an alternative embodiment;

FIG. 13 shows the first seal and the air passage reconstitution member of the embodiment of FIG. 12, in the unstressed state;

FIG. 14 is a view similar to that of FIG. 12, with the membrane provided with more than one additional air passage reconstitution member;

FIG. 15 shows the first seal, the air passage reconstitution member, and the additional air passage reconstitution member of the embodiment of FIG. 14, in the unstressed state;

FIG. 16 shows a partial perspective view of the reverser shown in FIG. 14, with the membrane deployed as arranged in the reverse thrust configuration;

FIG. 17 is a view similar to that of FIG. 7, showing an alternative embodiment of the first seal;

FIG. 18 shows the first seal of FIG. 17, in the unstressed state;

FIG. 19 is a perspective view showing a circumferential end of a movable cowl of the reverser shown in FIG. 10;

FIG. 20 is a perspective view showing the circumferential end of the movable reverser cowl of FIG. 19, cooperating with the fixed structure of the reverser;

FIG. 21 is a perspective view similar to that of FIG. 20, to which the closing membrane has also been added; and

FIG. 22 is a perspective view similar to that of FIG. 21, on which a deflection edge of the fixed structure of the reverser has also been added, in transparency.

### DETAILED DESCRIPTION OF SOME EMBODIMENTS

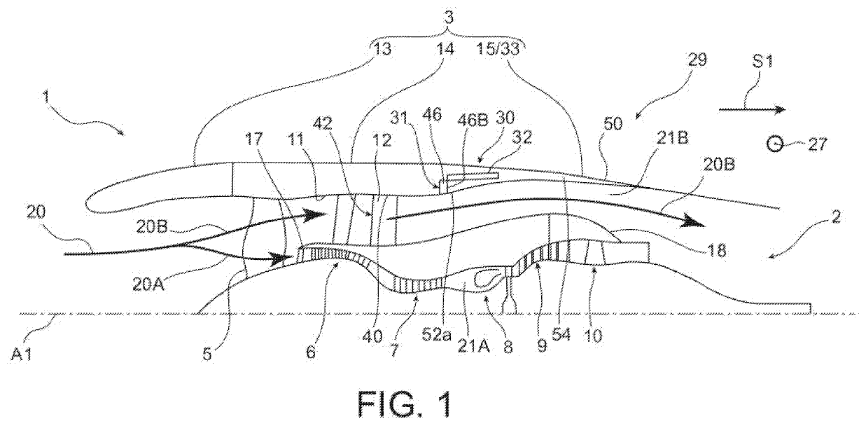

An aircraft propulsion assembly 1 is shown in FIG. 1, having a longitudinal central axis A1.

Subsequently, the terms “upstream” and “downstream” are defined relative to a general direction S1 of flow of gases through the propulsion assembly 1, along the axis A1 when it is generating thrust. These “upstream” and “downstream” terms may be substituted by the terms “front” and “rear”, respectively, with the same meaning.

The propulsion assembly 1 comprises a turbine engine 2, a nacelle 3 as well as a mast (not shown), intended to connect the propulsion assembly 1 to a wing (not shown) of the aircraft.

The turbine engine 2 is, in this example, a bypass, twin-spool turbojet engine comprising, from front to back, a fan 5, a low-pressure compressor 6, a high-pressure compressor 7, a combustion chamber 8, a high-pressure turbine 9 and a low-pressure turbine 10. The compressors 6 and 7, the combustion chamber 8 and the turbines 9 and 10 form a gas generator. The turbojet engine 2 is provided with a fan casing 11 connected to the gas generator by structural arms 12.

The nacelle 3 comprises a front section forming an air inlet 13, a middle section that comprises two fan cowls 14 enveloping the fan casing 11, and a rear section 15.

In operation, an air flow 20 enters the propulsion assembly 1 through the air inlet 13, passes through the fan 5 then splits into a primary flow 20A and a secondary flow 20B.

The primary flow 20A flows into a primary air passage 21A for the circulation of gases passing through the gas generator. The secondary flow 20B flows into a secondary air passage 21B surrounding the gas generator. The secondary air passage 21B is delimited radially inwards by a fixed inner shroud that surrounds the gas generator. In this example, the fixed inner shroud comprises a first segment 17 belonging to the middle section 14, and a second segment 18 extending towards the rear from the first segment 17, so as to form a portion of the rear section 15. This second segment 18 is an integral part of a fixed structure of a thrust reverser which will be described below. This same segment will subsequently be referred to as the radially inner wall 18 delimiting the secondary air passage 21B.

Radially outwards, the secondary air passage 21B is delimited by the fan casing 11, and, in the configuration of FIG. 1, by one or more movable reverser cowls 33 forming a portion of the rear section 15 of the nacelle 3, and which will be described later. More precisely, between the fan casing 11 and the reverser cowls 33, an outer ferrule 40 of an intermediate casing 42 is provided, the latter comprising the aforementioned structural arms 12, the radially outer end of which is attached to this ferrule 40. It therefore also contributes to delimiting the secondary air passage 21B radially outwards, by being located in the axial extension downstream of the fan casing 11.

The nacelle 3 therefore comprises a thrust reverser 30 centered on the axis Al and comprising, on the one hand, a fixed structure 31 integral with the fan casing 11, and, on the other hand, a structure 29 movable relative to the fixed structure 31. The fixed structure 31 comprises, for example, a front frame 46 which fixedly connects it to the fan casing 11, preferably via a knife-edge assembly located downstream of the outer ferrule 11. This front frame 46 contains a profiled aerodynamic part referred to as the deflection edge 46B, which guides the reverse jet flow.

In this case, the fixed structure 31 also comprises a plurality of deflection cascades 32 arranged adjacent to one another about the axis A1, in a circumferential direction 27 of the reverser 30 and of the propulsion assembly 1. Moreover, the movable structure 29 comprises the aforementioned movable reverser cowls 33, for example two cowls 33 each extending over an angular amplitude of about 180°. This two-cowl configuration 33 is particularly well suited in the case of a nacelle design wherein the cowls/walls 18 are also mounted articulated, the reverser 30 then having a so-called “D-Duct” architecture. In this architecture, the cowls 18, 33 are connected so as to open/close simultaneously during maintenance operations on the engine. Nevertheless, other architectures are possible, such as a so-called “C-Duct” architecture, or a so-called “O-Duct” architecture.

Each movable reverser cowl 33 comprises a radially outer wall 50, forming an outer aerodynamic surface of the reverser and of the nacelle, this surface being surrounded by the outside air. Each cowl 33 also comprises a radially inner wall 52 participating in the delimitation of the secondary air passage 21B radially outwards. This wall 52 is located in the downstream continuity of the deflection edge 46B. The two walls 50, 52 define a cavity 54 that is preferably open axially upstream, at the upstream end of the reverser cowl 33.

FIG. 1 shows the reverser 30 in a forward thrust configuration, known as “direct jet”, corresponding to a standard flight configuration. In this configuration, the cowls 33 of the movable structure 29 are in a closed position, known as extended “direct jet” or thrust position, wherein these reverser cowls 33 are bearing on the fixed structure 31, in particular on the deflection edge 46B forming an integral part of the latter. Indeed, in the direct thrust configuration, the upstream end 52a of the radially inner wall 52 of each cowl 33 axially bears against the deflection edge 46B, in this case via a sealing system specific to the invention, and which will be described below.

The movable cowl 33 is held in the extended direct thrust position by means for locking this cowl on the fixed structure 31 of the reverser. These controlled locking means (not shown) are conventional, therefore they will not be described further.

The movable structure 29 is thus translatable relative to the fixed structure 31 along the axis A1 of the reverser, between the extended direct thrust position shown in FIG. 1, and a retracted reverse thrust position that will be described later. When the movable structure 29 is in the extended direct thrust position, the deflection cascades 32 are arranged in the cavity 54 of the reverser cowls 33, isolated from the secondary air passage 21B by the radially inner wall 52 of these sliding reverser cowls 29. This wall 52, forming the outer wall of the secondary air passage, is also referred to as the acoustic inner panel.

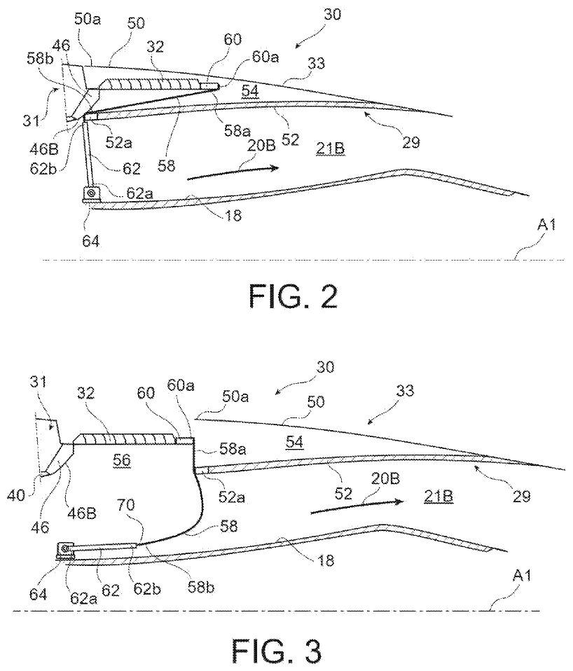

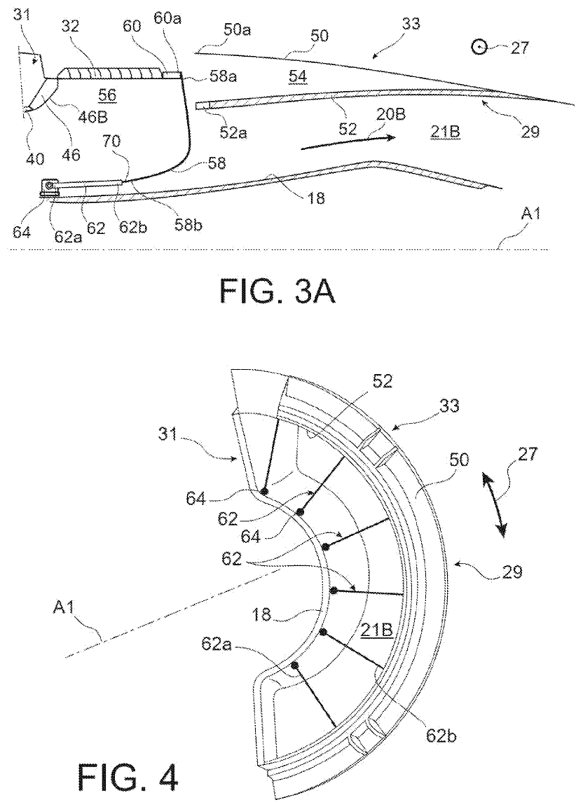

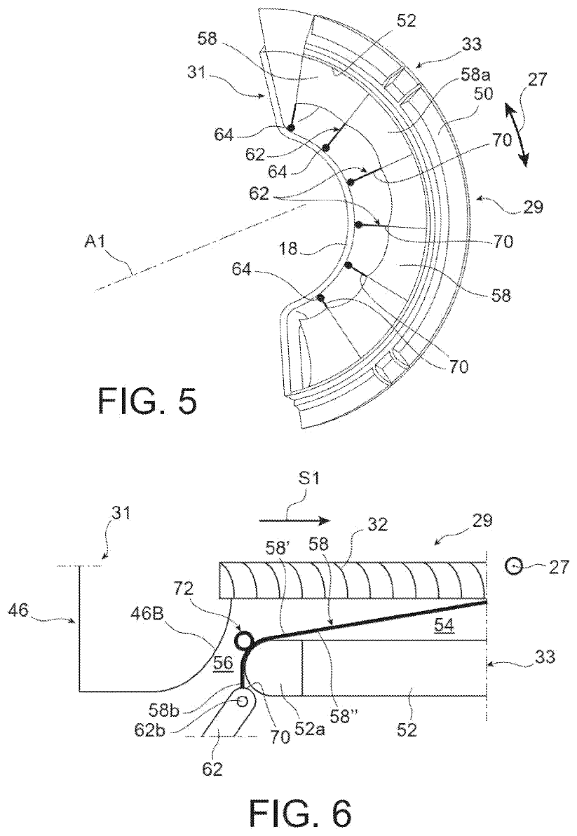

This direct thrust configuration is also shown in FIGS. 2 and 4, whereas the retracted reverse thrust position of the movable structure 29 is shown in FIGS. 3 and 5. In FIG. 3, it is shown that the retracted inner acoustic panel 52 of the movable reverser cowls reveals upstream a passage opening 56 leading from the secondary air passage 21B to the deflection cascades 32. The opening 56 is therefore also delimited upstream by the deflection edge 46B, which widens radially outwards towards the rear, to direct an air flow intended to pass through the cascades 32 when the movable system is in this retracted reverse thrust position. In other words, the deflection edge 46B gradually moves away from the axis A1 when going from the front towards the rear, to guide/deflect the air towards the cascades 32 in the reverse thrust configuration.

Downstream, the passage opening 56 is delimited in particular by the upstream end 52a of the radially inner wall 52.

In order to deflect at least one portion of the secondary flow 20B to the passage opening 56 defined axially between the deflection edge 46B and the upstream end 52a of the radially inner wall 52 of each cowl 33, the reverser 30 comprises, in this preferred embodiment, one or more closing membranes 58. Subsequently, an embodiment will be described wherein a single membrane 58 is associated with each reverser cowl 33 having an identical or similar angular amplitude; however, a plurality of circumferentially adjacent membranes associated with each cowl 33 remains possible. Similarly, only the cooperation between a membrane 58 and the associated cowl 33 thereof will be described below, it being understood that this cooperation is identical or similar for all the cowls of the reverser 33.

The membrane 58 may be made of a material known to a person skilled in the art for this type of application. For example, it may be an unimpregnated fabric, for example aramid fibers. The membrane 58 can also be produced using a composite material, the matrix of which is particularly flexible, for example made of aliphatic polyurethane, which makes it possible to be used under different temperature conditions, in particular under lower temperatures in the case of an aliphatic polyurethane membrane than in the case of a silicone membrane. The matrix results in a low capacity to bend back and the behavior of the structure obtained is indeed that of a membrane. One of the major properties of this membrane 58 is that it is able to be folded perfectly reversibly (elastically or by sliding fibers) with a very small radius of curvature relative to the surface thereof, and that it has a very small thickness, for example in the order of 0.1 to 3 mm. For information purposes, it can be seen that this membrane 58 behaves like a boat sail or a parachute/flying wing when it is pressurized.

Also with reference to FIGS. 1 to 5, first attachment means are provided, connecting a first end 58a of the closing membrane 58 to a rear frame 60 for supporting the cascades 32, this annular support or annular segment-shaped support effectively connecting the rear end of a plurality of adjacent cascades. In addition, second attachment means connect a second end 58b of the closing membrane 58, opposite the first membrane 58a, to the wall 18.

Furthermore, as can be seen in FIGS. 1, 2 and 4, when the movable structure 29 occupies the extended direct thrust position thereof, at least one portion of the closing membrane 58 is arranged radially between the deflection cascades 32 and the radially inner wall 52 of the reverser cowl 33, in the cavity 54. Preferably, the portion of the membrane 58 that is in this cavity 54 of the reverser cowl 33 radially covers the entire length of the cascades 32. Consequently, when the movable structure 29 adopts the extended direct thrust position thereof, the second end 58b of the membrane 58 is clamped, or simply arranged, between the upstream end of the wall 52, and the deflection edge 46B.

In addition, as can be seen in FIG. 3, when the movable structure 29 moves and when it occupies the retracted reverse thrust position thereof at the end of this movement, the closing membrane 58 is partially bearing against the upstream end 52a of the radially inner wall 52 of the reverser cowl, therefore corresponding to the acoustic panel. More precisely, during the movement towards the rear of the movable structure 29, the membrane 58 slides on this upstream end 52a of the radially inner wall 52.

In the retracted reverse thrust position of FIG. 3, the membrane 58 is therefore axially bearing downstream against the upstream end 52a. It should be noted that, depending on the extent of the axial travel of the reverser, the membrane 58 may no longer be in contact with the inner acoustic panel 52 in the fully deployed position of the reverser, where the cowl 33 is in the most retracted position thereof. Such a configuration is shown in FIG. 3A, wherein it is shown that the membrane 58 is upstream and away from the upstream end 52a of the wall 52 of the reverser cowl. The contact option corresponds to a minimized travel of the reverser, whereas the non-contact option generally corresponds to a smoother membrane shape in the reverse jet configuration, therefore performing better from an aerodynamic point of view.

Thus, the portion of the membrane 58 that is located radially outwards relative to the bearing zone thereof on the wall 52 closes off a portion of the axial opening upstream of the cavity 54, whereas the other portion located radially inwards closes off at least one portion of the secondary air passage 21B, thereby deflecting at least one portion of the secondary flow 20B towards the passage opening 56 in the direction of the cascades 32. Another possibility, not shown, consists in performing the radially external attachment of the membrane 58 to the radially outer wall 50 of the sliding cowl 33. The end 58b of the membrane 58 has cables 70 connected to the wall 18 (also referred to as IFS or “Inner Fixed Structure”), by a connection which may advantageously exert a tensile force on each cable 70 returning it to this wall 18, for example by means of an elastic connection. The cables 70 themselves can be elastic, for example by using Kevlar cables, and these same cables can be tensioned when the sliding cowl 33 is closed. Reinforcements may be Integrated into the membrane 58 in the continuation of these cables 70, up to the external attachment points with the rear cascade support frame 60, or the outer wall 50 of the sliding cowl 33.

These cables 70 are advantageously positioned radially in the air passage while being circumferentially spaced apart from each other. In the direct jet position, they tension the membrane 58 between the end 58a thereof and the leading edge/the upstream end 52a of the wall 52 of the cowl. During deployment, when the sliding cowl 33 retracts, the cables 70 pull the membrane 58 towards the secondary air passage so that it takes air therein and gradually deploys therein.

According to the purpose sought, the second attachment means may consist of connecting rods 62, instead of the cables mentioned above. A first end 62a of each of them is mounted on the wall 18, preferably by means of a pivot or ball joint connection 64. This connection 64 may be produced using a fitting attached to the fixed wall 18 and cooperating with the first end 62a of the connecting rod.

The connecting rods 62 are circumferentially spaced apart from one another within the secondary air passage 21B, and the number thereof may, for example, vary from two to ten.

Each connecting rod 62 is designed to move from a radially protruding position in the secondary air passage 21B, which position is shown in FIGS. 2 and 4, and which is adopted when the movable structure 29 occupies the extended direct thrust position thereof, into a position folded downstream, as shown in FIGS. 3 and 5 and adopted when the movable structure 29 occupies the retracted reverse thrust position thereof.

Elastic return means may be provided to bias each connecting rod 62 to tilt towards the folded/lying down position thereof in FIG. 3, in particular when the connecting rod is in the protruding position thereof corresponding to the flight position of the reverser.

The second end 62b of each connecting rod 62, opposite the first end 62a, can be connected directly to the second end 58b of the membrane 58. Nevertheless, other preferred solutions are retained, such as those aiming to integrate cables or reinforcement straps within the second attachment means.

In the embodiment shown in FIGS. 1 to 5, the cables 70 cooperate with the connecting rods 62 by each being attached to the second end 62b of one of the connecting rods associated with this cable. Alternatively, the cables 70 may pass through the associated connecting rods 62 thereof to be attached to the radially inner wall 52 delimiting the secondary air passage, for example via the fittings 66.

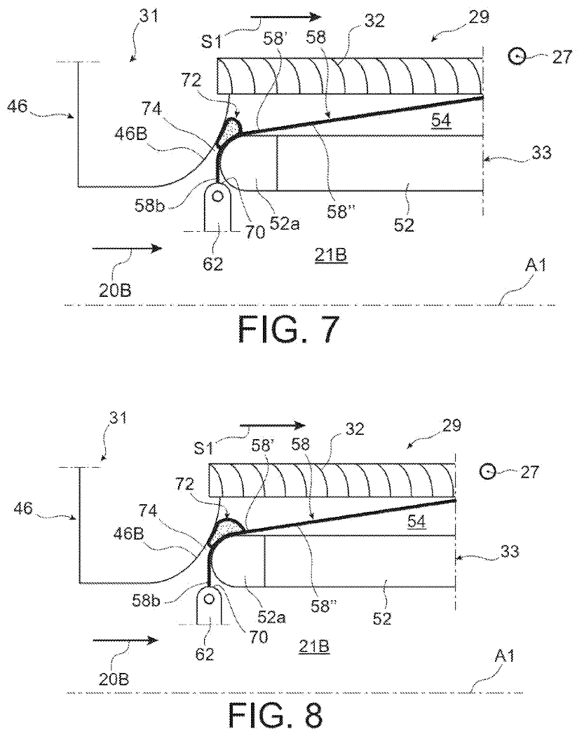

One of the particularities of the invention lies in the fact that the reverser closing membrane 58 is provided with a first seal 72, projecting near the second end 58b of the closing membrane 58. This specificity is shown in FIGS. 6 and 7. The first seal 72 is located on the side of a surface 58′ of the membrane which is oriented forward, protruding from this surface 58′ also forward in the direct thrust configuration. The first seal 72 is preferably continuous along the entire length of the membrane 58, extending in the circumferential direction 27.

In the unstressed state shown in FIG. 6, the first seal 72 has a circular or substantially circular cross-section. In the stressed state shown in FIG. 7, it bears on the one hand against the deflection edge 46B, and on the other hand against the rounded upstream end 52a of the radially inner wall 52 of the movable cowl.

Also in the stressed state as adopted in the direct thrust configuration, the first seal 72 is preferably located so as to extend radially outwards beyond the upstream end 52a. It is therefore located radially outwards relative to a minimum spacing zone 74 between the deflection edge 46B and the upstream end 52a of the wall 52. As illustrated in FIG. 7, the first seal 72 can be forced towards the minimum spacing zone 74 between the deflection edge 46B and the upstream end 52a, by the geometry of the assembly, and/or by the traction exerted by the connecting rods 62 at the end of the retracting phase of the movable cowl 33.

It should be noted that, alternatively, the first seal 72 could be arranged, in the stressed state, radially inwards relative to the minimum spacing zone 74, or even crosswise over this same zone by extending radially on either side thereof.

In order to produce this seal 72, it can simply be bonded to the surface 58′ of the membrane, sewn thereto, co-vulcanized, or attached by any technique deemed appropriate for a person skilled in the art.

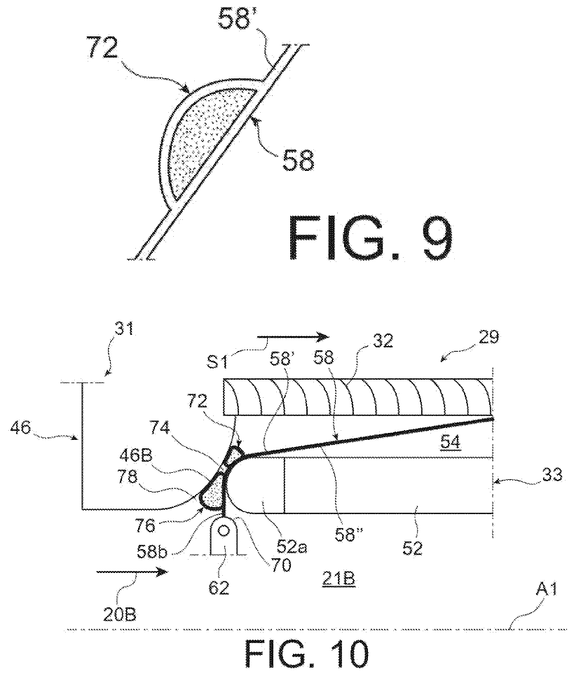

By way of example, as shown in FIGS. 8 and 9, the first seal 72 can be embedded in the membrane, i.e. inserted between the membrane 58 and another fabric panel lining this membrane, so as to ensure structural and geometric continuity around the seal. In the example shown, the first seal 72 takes the general shape of a water drop on a plane, but other shapes remain possible, without departing from the scope of the invention.

It should be noted that in the embodiments just described, as in those which will be disclosed hereinafter, the membrane 58 can further be clamped between the deflection edge 46B and the rounded end 52a in the direct thrust configuration, or alternatively a small play can be observed, without departing from the scope of the invention.

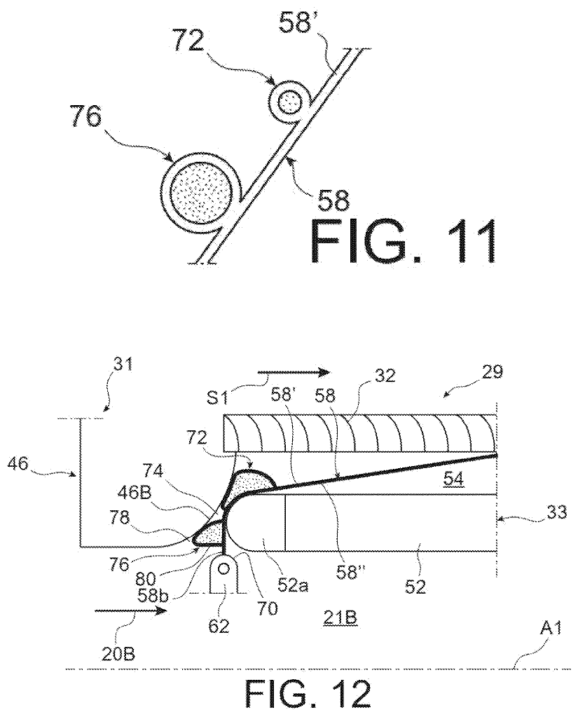

With reference now to FIGS. 10 and 11, another embodiment is shown in which the first seal remains located radially outwards relative to the minimum spacing zone 74, and in which the membrane 58 also supports a secondary air passage reconstitution member 76. In this case, the reconstitution member 76 also extends in the circumferential direction 27, being continuous along the entire length of the membrane 58, or segmented, for example interrupted circumferentially at each connection of a connecting rod 62.

The member 76 is also preferably protruding forwards from the surface 58′ of the membrane and is located radially inwards relative to the minimum spacing zone 74. Of course, either of the member 76 and the first seal 72 could be forced to deform through the minimum spacing zone 74, without departing from the scope of the invention.

In this embodiment, the reconstitution member 76 forms a second seal which, in the stressed state, also bears on the one hand against the deflection edge 46B, and on the other hand against the rounded upstream end 52a of the wall 52 of the movable cowl 33. This sealing function is added to that conferred by the first seal 72, thereby reinforcing the barrier against the secondary flow 20B that must be maintained as best as possible in the air passage 21B, by limiting radially outward air leaks between the edge 46B and the end 52a in the direct thrust configuration. In addition, the fact of having two elements 72, 76 on either side radially of the minimum spacing zone 74, each stressed between the fixed edge 46B and the rounded end 52a, reinforces the holding of the membrane 58 stored in the cavity 54 of the movable cowl 33.

The main function of the member 76 indeed consists in filling all or part of a cavity 78 between the deflection edge 46B and the upstream end 52a, resulting from the rounded shape of these two elements bearing against one another or in close proximity, in the reverse thrust configuration. This cavity 78, referenced in FIG. 10, therefore has a concave shape that widens radially inwards. The more this cavity 78 is filled by the reconstitution member, the more the load losses are limited, and the aerodynamic performance is increased.

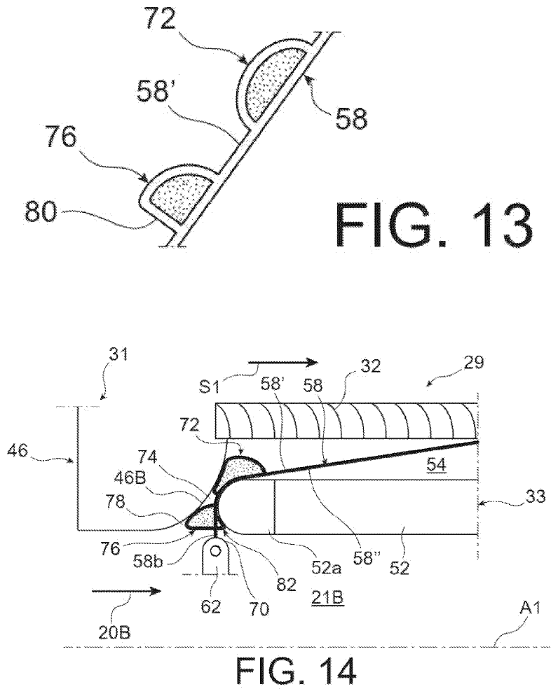

This principle applies regardless of the shape of the joints 72, 76, whether they have a circular or substantially circular cross-section in the unstressed state, as in the embodiment in FIGS. 10 and 11, or whether they have a more complex cross-section, as in the embodiment in FIGS. 12 and 13.

In these FIGS. 12 and 13, the first seal 72 has a water drop-shaped cross-section on a plane, whereas the reconstitution member 76 has a more complex shape. More specifically, it is such that, in the stressed state, in the direct thrust configuration, the surface 80 of this member which is located furthest inward in the radial direction, and which therefore contributes to delimiting the secondary air passage 21B radially inwardly, ensures aerodynamic continuity or significant aerodynamic continuity with the deflection edge 46B, and/or with the radially inner surface of the end 52a. In particular, in the embodiment in FIG. 12, the surface 80 of the member 76 lies in the substantial axial continuity of the entrance to the deflection edge 46B, only a cavity 78 of very small dimensions being able to remain therebetween.

A reinforcement insert can be integrated into the reconstitution member 76, along its surface 80, so as to more easily impose the desired shape thereon for the reconstitution of the air passage. This insert (not shown in FIG. 12), can be housed inside the member 76, or form an external part thereof.

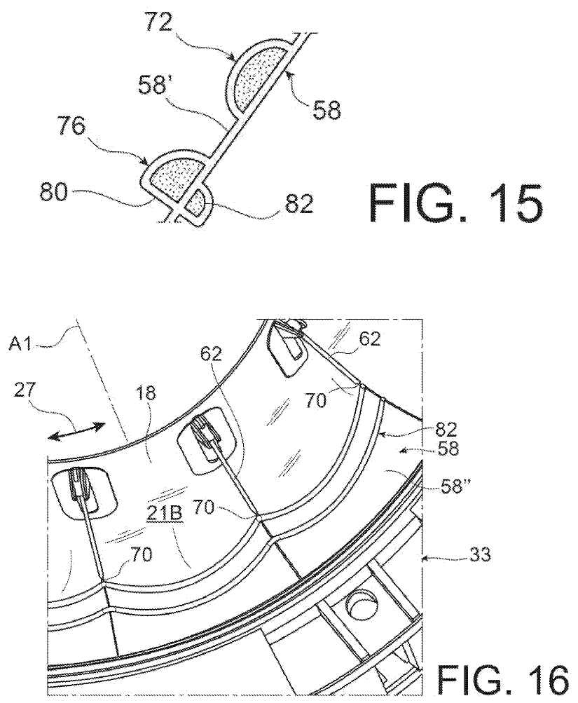

FIGS. 14 and 15 represent another embodiment in which an additional air passage reconstitution member 82 is also provided. This additional member 82 is arranged protruding from the membrane 58 which supports it, from a surface 58″ located on the opposite side to that of the surface 58′ supporting the seals 72, 76, namely towards the rear. This additional member 82 can also fulfill a seal function, by being stressed such that it bears against the second seal 76 on the one hand, and against the rounded end 52a on the other hand. It may also have a radially inner surface that best reconstitutes the shape of the air passage 21B, in order to limit the load losses.

The additional air passage reconstitution member 82 is preferably segmented in the circumferential direction 27, as can be seen in FIG. 16. This segmentation is preferably carried out at each connection of a connecting rod 62 to the membrane 58, via the cables 70 which generate linear tension zones on the membrane in the reverse thrust configuration.

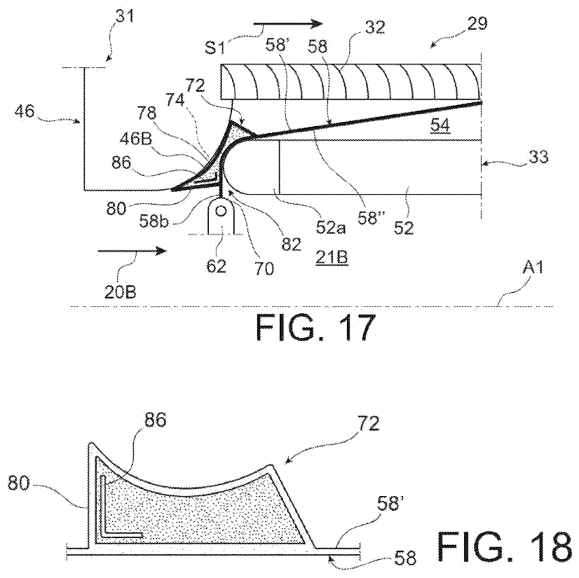

FIGS. 17 and 18 show another alternative in which only a single first seal 72 protrudes from the surface 58′ of the membrane 58. The seal 72, of substantially rectangular cross-section in the unstressed state, thus extends radially on either side of the minimum spacing zone 74, passing therethrough. In this embodiment, the seal 72 integrates, in a radially inner part filling all or part of the cavity 78, a reinforcing insert 86 located along the surface 80 reconstituting the air passage 21B.

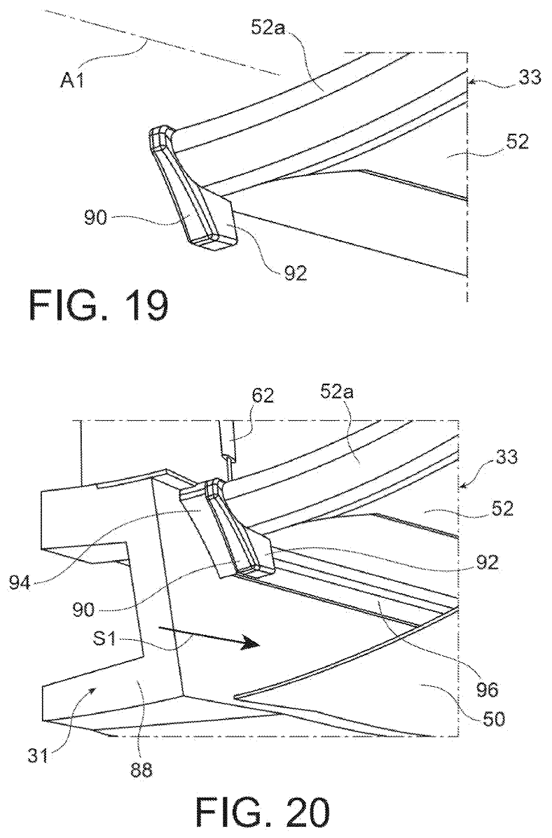

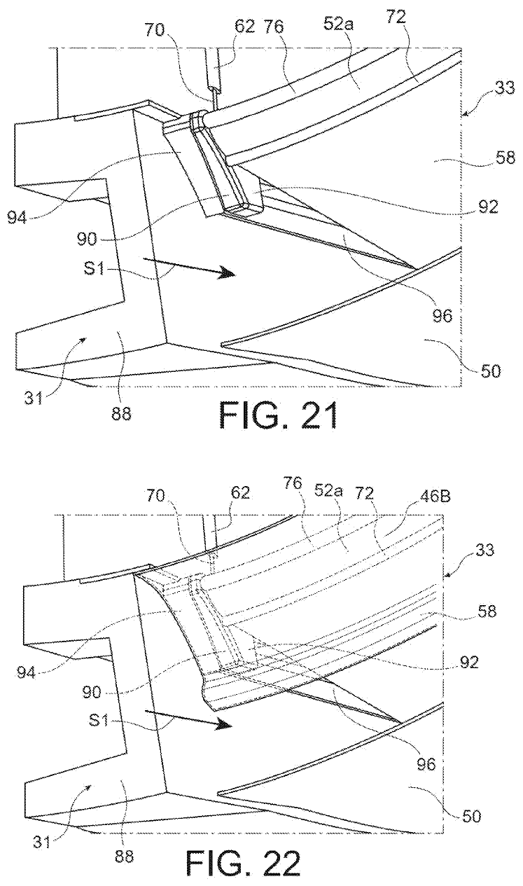

FIGS. 19 to 22 show the sealing obtained at a circumferential end of the membrane 58, also corresponding in this case to a circumferential end of the movable cowl 33 and its wall 52, cooperating with a beam 88 of the fixed structure 31. This beam 88 can be arranged in the 6 o'clock position, or the 12 o'clock position.

The circumferential end of each of the seals 72, 76 circumferentially bears against a block-shaped end seal 90, and is fixedly supported by a guide member of the membrane 92 rigidly connected to the movable cowl, extending radially outwards relative to the annular front end 52a of the wall 52. Thus, when the movable cowl 33 occupies its extended direct thrust position, the end of the two seals circumferentially bears against the end seal 90, which also makes it possible, during the extension and retraction of the membrane 58, to provide even better guidance thereof in association with the guide member 92.

To complete the sealing with the fixed structure 31, the end seal 90 circumferentially bears against a fixed seal 94 supported by the fixed structure, when the movable structure occupies its extended direct thrust position. The fixed joint 94, which is also block-shaped, can be supported by the beam 88, preferably being located at the front end of a guide rail 96 rigidly connected to the beam 88 and serving to guide the movable flap 33 in translation.

The interface between the two seals 90, 94 can have a suitable slope, so as to facilitate the axial docking of the movable cowl, at the end of its closing travel.

A multi-seal arrangement of this type is also provided at the opposite circumferential end of the cowl 33/the membrane 58.

Various modifications may be made by a person skilled in the art to the invention just described, only by way of non-limiting examples, and the scope of which is defined by the appended claims. For example, the thrust reverser 30 can alternatively have a “C-Duct” or “O-Duct” architecture. Furthermore, if the preferred embodiments described above relate to a design of a reverser with fixed deflection cascades, these cascades can alternatively be integrated into the movable structure of the reverser. Finally, the technical features of the various embodiments described above are interchangeable and combinable.

1. A thrust reverser for an aircraft propulsion assembly, the reverser comprising a fixed structure provided with a wall radially internally delimiting a secondary air passage of the propulsion assembly intended to be passed through by a secondary flow the reverser further comprising a movable structure comprising at least one movable reverser cowl having a cavity that is open at the front and delimited between a radially outer wall and a radially inner wall of the movable reverser cowl the movable structure being translatable relative to the fixed structure along a longitudinal central axis of the reverser, between an extended direct thrust position, and a retracted reverse thrust position wherein the fixed structure and an upstream end of the retracted radially inner wall of the reverser movable cowl allow an air passage opening through the secondary air passage to appear therebetween, the thrust reverser further comprising means for closing the secondary air passage, designed to divert at least a part of the secondary flow towards the passage opening these means comprising at least one closing membrane deployable in the secondary air passage and running between the fixed structure and the upstream end of the radially inner wall when the movable structure occupies its extended direct thrust position,
wherein said at least one membrane supports a first seal extending in a circumferential direction of the reverser, bearing on the one hand against the fixed structure and on the other hand against the upstream end of the radially inner wall of the movable cowl, when the movable structure occupies its extended direct thrust position.

2. The thrust reverser according to claim 1, wherein the first seal is located radially outwards relative to a zone of minimum spacing between the fixed structure and the upstream end of the radially inner wall or radially inwards relative to this zone of minimum spacing or even crosswise over this same zone by extending radially on either side thereof.

3. The thrust reverser according to claim 2, wherein the first seal is located radially outwards relative to the minimum spacing zone and wherein said at least one closing membrane also supports a secondary air passage reconstitution member extending in the circumferential direction located radially inwards relative to the minimum spacing zone so as to fill all or part of a cavity between the fixed structure and the upstream end of the radially inner wall

4. The thrust reverser according to claim 3, wherein the air passage reconstitution member is located on the side of a forward-facing surface of the closing membrane

5. The thrust reverser according to claim 1. wherein the first seal is located on the side of a forward-facing surface of the closing membrane

6. The thrust reverser according to claim 1, wherein the first seal bears on the one hand against a deflection edge of the fixed structure, and on the other hand against the upstream end of the radially inner wall when the movable structure occupies its extended direct thrust position.

7. The thrust reverser according to claim 1, wherein at least one of the two circumferential ends of the first seal circumferentially bears against an end seal supported by a guide member of the membrane rigidly connected to the movable cowl when the movable structure occupies its extended direct thrust position,

8. The thrust reverser according to claim 7, wherein the end seal circumferentially bears against a fixed seal supported by the fixed structure when the movable structure occupies its extended direct thrust position.

9. The thrust reverser according to claim 1. wherein the fixed structure of the reverser comprises at least one deflection cascade arranged, in the extended direct thrust position of the movable structure, in the cavity of the movable cowl, isolated from the secondary air passage by the radially inner wall of the reverser cowl

10. An aircraft propulsion assembly comprising a turbine engine and a nacelle including at least one fan cowl as well as a thrust reverser according to claim 1.
